(19) United States
(12) Patent Application Publication
(10) Pub. No.: US 2026/0086229 A1
(43) Pub. Date: Mar. 26, 2026

(54) HIGH-EDGE ANTENNAS FOR OPTIMIZED SAR PERFORMANCE

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/897,590

(22) Filed: Sep. 26, 2024

(51) Int. Cl. G01S 13/90

(52) U.S. Cl. CPC G01S 13/9021; G01S 13/9017

(57) ABSTRACT

A method includes transmitting radar signals toward a target area via a phased array antenna of a synthetic aperture radar (SAR) antenna system, receiving reflected radar signals from the target area, performing, via a signal processor, one or more SAR algorithms to convert the reflected radar signals into one or more images, video, and/or measurements of the target area, receiving one or more of ground-based visual data, aerial data, and/or historical or architectural data, integrating the ground-based visual data, the aerial data, and/or the historical or architectural data with the one or more images, video, and/or measurements produced by the SAR antenna system to produce a cohesive visualization, and sending the visualization to a user device for display and interaction therewith.

### FIELD OF THE DISCLOSURE

The present disclosure relates to synthetic aperture radar (SAR) and, more specifically, to to high-edge antennas for optimized SAR performance.

### BACKGROUND

Traditional radar systems struggle to provide high-resolution images in complex urban environments, where buildings and other structures can obscure important details. This limitation affects the accuracy and reliability of the data collected for urban planning and infrastructure monitoring. Also, the presence of high-rise buildings and other large structures in cities can create shadow zones where traditional radar systems cannot capture detailed imagery. This lack of comprehensive coverage leads to gaps in data. Lastly, in highly developed urban areas, traditional radar technologies struggle with signal interference and multipath effects caused by reflective surfaces like glass and metal. These challenges result in distorted images and unreliable data. Thus, there is a need in the prior art for high-edge antennas for optimized SAR performance.

### SUMMARY

The present disclosure solves the deficiencies of traditional approaches by providing a high-edge antenna system and method for optimized synthetic aperture radar (SAR) performance. According to one aspect, a system includes a synthetic aperture radar (SAR) antenna system including a phased array antenna configured to transmit radar signals toward a target area. The system also includes a signal processing unit configured to receive reflected radar signals from the target area and perform one or more SAR algorithms to convert the reflected radar signals into one or more images, video, and/or measurements of the target area. The system further includes at least one data integrator configured to receive one or more of ground-based visual data, aerial data, and/or historical or architectural data, integrate the ground-based visual data, the aerial data, and/or the historical or architectural data with the one or more images, video, and/or measurements produced by the SAR antenna system to produce a cohesive visualization, and send the visualization to a remote system or device for storage, display and/or interaction therewith.

In some embodiments, the system further includes a generative AI module configured to perform one or more of filling one or more gaps in the one or more images, video, and/or measurements and/or the ground-based visual data, the aerial data, and/or the historical or architectural data; and/or increase a resolution of the one or more images, video, and/or measurements and/or the ground-based visual data, the aerial data, and/or the historical or architectural data.

In some embodiments, the at least one data integrator is further configured to temporally and/or spatially align the ground-based visual data, the aerial data, and/or the historical or architectural data with the one or more images, video, and/or measurements produced by the SAR antenna system.

In some embodiments, the at least one data integrator is configured to temporally align via timestamps the ground-based visual data, the aerial data, and/or the historical or architectural data with the one or more images, video, and/or measurements produced by the SAR antenna system.

In some embodiments, the at least one data integrator is configured to temporally align the ground-based visual data, the aerial data, and/or the historical or architectural data with the one or more images, video, and/or measurements produced by the SAR antenna system using temporal interpolation.

In some embodiments, the at least one data integrator is configured to spatially align the ground-based visual data, the aerial data, and/or the historical or architectural data with the one or more images, video, and/or measurements using a registration process.

In some embodiments, the at least one data integrator is configured to spatially align the ground-based visual data, the aerial data, and/or the historical or architectural data with the one or more images, video, and/or measurements using spatial coordinates associated therewith. The spatial coordinates may include global positioning system (GPS) coordinates.

In some embodiments, the at least one data integrator is configured to integrate the ground-based visual data, the aerial data, and/or the historical or architectural data with the one or more images, video, and/or measurements produced by the SAR antenna system using a data fusion process.

In some embodiments, the at least one data integrator is configured to normalize the ground-based visual data, the aerial data, the historical or architectural data, and/or or more images, video, and/or measurements to account for differences in scale, resolution, and/or perspective.

In some embodiments, the at least one data integrator is configured to rescale or reproject the ground-based visual data, the aerial data, the historical or architectural data to match a resolution of the one or more images, video, and/or measurements, or wherein the at least one data integrator is configured to rescale or reproject the images, video, and/or measurements to match the resolution of the ground-based visual data, the aerial data, and/or the historical or architectural data.

In some embodiments, the at least one data integrator includes a sensor data integrator configured to receive the ground-based visual data from one or more of data sources including one or more street cameras and/or traffic light cameras.

In some embodiments, the at least one data integrator includes a drone data integrator configured to receive the aerial data from one or more drones.

In some embodiments, the at least one data integrator includes a historical data integrator configured to receive the historical or architectural data including one or more of architectural plans, blueprints, construction plans, historical photographs, and/or zoning maps.

In some embodiments, the historical data integrator is configured to perform Optical Character Recognition (OCR) to produce text data from the one or more images and/or video.

In some embodiments, the one or more SAR algorithms include one or more of a Range-Doppler Algorithm, a Chirp Scaling Algorithm, a Polar Format Algorithm, and/or a Backprojection Algorithm.

In some embodiments, the signal processing unit is further configured to enhance the one or more images using at least one of noise reduction, contrast enhancement, edge sharpening, artifact or distortion removal, Kalman filtering, and/or Independent Component Analysis (ICA).

In some embodiments, the at least one data integrator operates in a cloud environment.

In some embodiments, the ground-based visual data, the aerial data, and/or the historical or architectural data are obtained from one or more third party sources.

In some embodiments, the visualization includes one or more of radar images, 3D models, layered maps, and analytical results.

In some embodiments, the remote system or device includes one or more of a user device, a centralized server, and/or a distributed or decentralized server.

In some embodiments, the distributed or decentralized server includes a peer-to-peer server.

In some embodiments, the system further includes or accesses artificial intelligence (AI) and/or machine learning (ML) to detect people, objects and/or events in the visualization.

According to another aspect, a method includes transmitting radar signals toward a target area via a phased array antenna of a synthetic aperture radar (SAR) antenna system. The method also includes receiving reflected radar signals from the target area, performing, via a signal processor, one or more SAR algorithms to convert the reflected radar signals into one or more images, video, and/or measurements of the target area. The method further includes receiving one or more of ground-based visual data, aerial data, and/or historical or architectural data. In addition, the method includes integrating the ground-based visual data, the aerial data, and/or the historical or architectural data with the one or more images, video, and/or measurements produced by the SAR antenna system to produce a cohesive visualization. Further, the method includes sending the visualization to a remote system or device for storage, display and/or interaction therewith.

In some embodiments, the method further includes using a generative AI module to fill one or more gaps in the one or more images, video, and/or measurements and/or the ground-based visual data, the aerial data, and/or the historical or architectural data; and/or increase a resolution of the one or more images, video, and/or measurements and/or the ground-based visual data, the aerial data, and/or the historical or architectural data.

In some embodiments, the method further includes temporally and/or spatially aligning the ground-based visual data, the aerial data, and/or the historical or architectural data with the one or more images, video, and/or measurements produced by the SAR antenna system.

In some embodiments, temporally aligning includes temporally aligning, via timestamps, the ground-based visual data, the aerial data, and/or the historical or architectural data with the one or more images, video, and/or measurements produced by the SAR antenna system.

In some embodiments, temporally aligning includes temporally aligning the ground-based visual data, the aerial data, and/or the historical or architectural data with the one or more images, video, and/or measurements produced by the SAR antenna system using temporal interpolation.

In some embodiments, spatially aligning includes spatially aligning the ground-based visual data, the aerial data, and/or the historical or architectural data with the one or more images, video, and/or measurements using a registration process.

In some embodiments, spatially aligning includes spatially aligning the ground-based visual data, the aerial data, and/or the historical or architectural data with the one or more images, video, and/or measurements using spatial coordinates associated therewith. The spatial coordinates may include global positioning system (GPS) coordinates.

In some embodiments, integrating includes integrating the ground-based visual data, the aerial data, and/or the historical or architectural data with the one or more images, video, and/or measurements produced by the SAR antenna system using a data fusion process.

In some embodiments, integrating includes normalizing the ground-based visual data, the aerial data, the historical or architectural data, and/or or more images, video, and/or measurements to account for differences in scale, resolution, and/or perspective.

### BRIEF DESCRIPTION OF THE DRAWINGS

FIG. 1 is a schematic diagram of a high-edge antenna for optimized SAR performance, according to an embodiment.

FIG. 2 is a flowchart of a method performed by a Processing Module, according to an embodiment.

FIG. 3 is a flowchart of a method performed by a Base Module, according to an embodiment.

FIG. 4 is a flowchart of a method performed by a Generative AI Module, according to an embodiment.

FIG. 5 is a flowchart of a method performed by a SAR Module, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

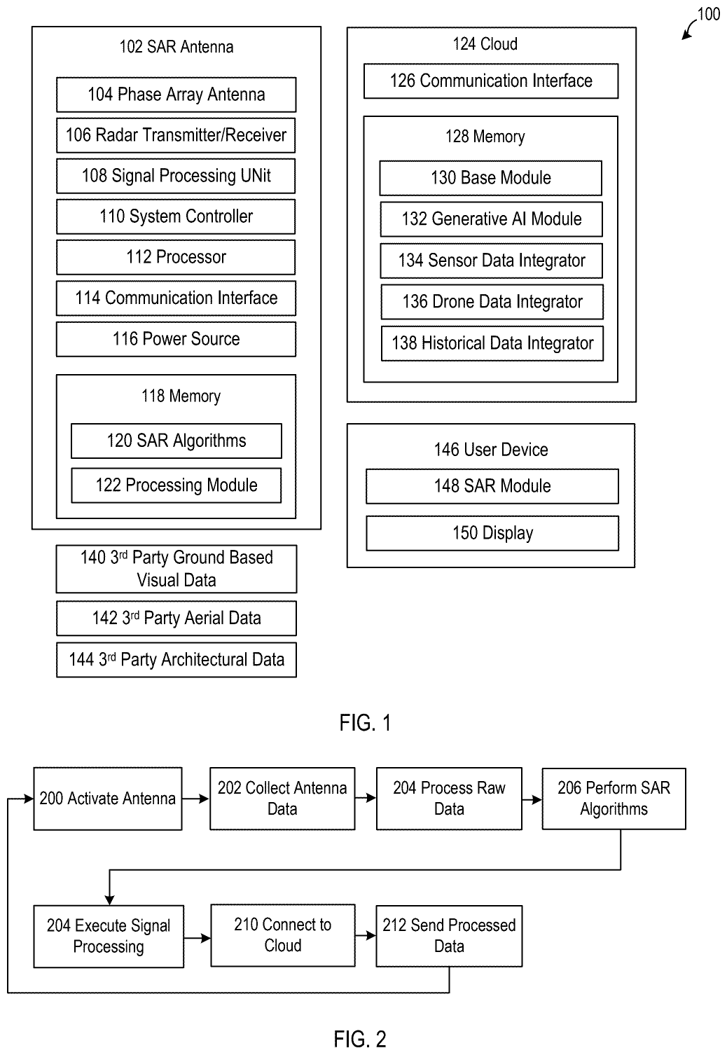

FIG. 1 illustrates a method for high-edge antennas for optimized SAR performance. This method includes a SAR antenna 102 that may be designed to generate high-resolution images by capturing reflected radar signals from the ground and various structures. The SAR Antenna 102 includes a phased array antenna 104, radar transmitter and receiver 106, signal processing unit 108, system controller 110, processor 112, communication interface 114, power source 116, memory 118, SAR algorithms 120, and a processing module 122. The SAR Antenna 102 may be designed to provide high-resolution imaging capabilities across a wide range of applications. The SAR antenna's phased array technology may allow for detailed mapping and monitoring of large areas, including urban environments, natural landscapes, and critical infrastructure. In some embodiments, the integration of generative AI and other processing techniques with the data collected by the SAR Antenna 102 allows for the filling of data gaps, correction of distortions, and enhancement of image quality, ensuring that the final products are accurate and detailed.

Further, embodiments may include a phased array antenna 104, which may be designed to transmit and receive radar signals for high-resolution imaging. The phased array antenna 104 may consist of multiple individual radiating elements, each capable of emitting and receiving electromagnetic waves. The phased array antenna 104 may electronically steer the radar beam without physically moving the antenna structure. In some embodiments, each antenna 104 element may be equipped with phase shifters that adjust the phase of the signal emitted. The radar beam may be directed in different directions by carefully controlling the phase across the array, allowing the system to focus on specific areas or targets and rapid scanning and adaptation to changing conditions. In some embodiments, the amplitude of the signals may be adjusted at each element to shape the beam and control the radiation pattern, optimizing the antenna's 104 performance, reducing side lobes, and increasing the main lobe's gain, enhancing the detection and resolution capabilities. In some embodiments, the synthetic aperture may be formed by collecting data from multiple angles over time. The data may be processed using SAR algorithms 120 to simulate the effect of a moving antenna 104, resulting in high-resolution images. In some embodiments, the phased array antenna's 104 ability to steer the beam electronically allows for continuous monitoring and data collection from a fixed position. In some embodiments, the phased array antenna 104 may cover a wide field of view by rapidly steering the beam across different directions. In some embodiments, the elements of the phased array antenna 104 may be made from advanced materials like gallium nitride, GaN, and gallium arsenide, GaAs. In some embodiments, the phased array antenna 104 may be constructed from materials that provide high power efficiency, thermal stability, and durability. In some embodiments, the phased array antenna 104 may be configured as an Active Electronically Scanned Array, or AESA, which may include solid-state transmit/receive modules, or TRMs, at each antenna element, allowing for simultaneous operation in multiple modes, such as air-to-air, air-to-ground, electronic warfare. In some embodiments, the phased array antenna 104 may be integrated with other SAR antenna 102 system components, such as the radar transmitter and receiver 106, signal processing unit 108, and system controller 110, allowing for synchronized operation, precise beam steering, and accurate data collection. In some embodiments, the system controller 110 and processor 112 may manage the phase and amplitude adjustments across the antenna array, coordinate the data acquisition, and process the received signals. In some embodiments, the system controller 110 and processor 112 may handle real-time adjustments to optimize the antenna's performance based on the operational environment and specific mission requirements.

Further, embodiments may include a radar transmitter and receiver 106, which may be responsible for emitting and capturing electromagnetic signals. The radar transmitter and receiver 106 may include generating the radar waves, directing them toward the target, and capturing the echoes reflected from objects within the radar's field of view. In some embodiments, the transmitter may generate a radar signal, such as a microwave frequency range. In some embodiments, the signal generator may create a coherent waveform, such as a chirped signal, which increases in frequency over time. The generated signal may be amplified to the required power level using high-power amplifiers. In some embodiments, the amplifiers may be designed to handle the specific power and frequency requirements of the radar system. The amplified signal may be sent to the phased array antenna 104, which then emits the radar waves into the environment. In some embodiments, the phased array antenna's 104 electronic steering allows the radar beam to be directed accurately, allowing the system to scan large areas or focus on specific targets. The radar receiver may be responsible for capturing the echoes reflected from the targets. In some embodiments, the phased array antenna 104 may act as both the transmitter and receiver and collect the reflected signals. In some embodiments, sensitive receivers may be used to receive the signals, which may be weak after traveling to the target and back. In some embodiments, the received signals may be passed through a low-noise amplifier, or LNA, which boosts the signal strength while minimizing additional noise to maintain the quality of the received signal. In some embodiments, the amplified signal may then be downconverted from the microwave frequency to an intermediate frequency, or IF or baseband using mixers, providing easier handling and processing of the signal. In some embodiments, the downconverted signal may be demodulated to extract the information content, such as range and Doppler shifts. In some embodiments, the analog signals may be converted into a digital format using Analog-to-Digital Converters, or ADCs, allowing for digital signal processing, where algorithms may analyze the data to construct images or detect targets. In some embodiments, the radar transmitter and receiver 106 may coordinate with the system controller 110 and signal processing unit 108. In some embodiments, the system controller 110 may synchronize the timing of signal transmission and reception, ensuring accurate range measurement and Doppler processing. In some embodiments, the radar transmitter and receiver 106 system may include adaptive processing techniques to dynamically adjust the radar's operating parameters based on environmental conditions or specific mission requirements. For example, the system may alter the pulse repetition frequency, PRF, or signal bandwidth to optimize detection capabilities. In some embodiments, the system may utilize techniques like filtering and shielding to reduce the impact of external sources of interference.

Further, embodiments may include a signal processing unit 108, which may be responsible for converting raw radar data into meaningful information, such as high-resolution images or target detections. The signal processing unit 108 may handle the complex tasks of analyzing the radar signals received from the antenna 104 and applying various algorithms to extract, enhance, and interpret the data. The signal processing unit 108 may receive digitized signals from the radar receiver after they have been amplified and downconverted. In some embodiments, the signals may represent the raw data collected by the radar system, including information about the range, velocity, and possibly the shape of objects in the radar's field of view. In some embodiments, the raw data may undergo preprocessing before applying various algorithms, including noise reduction, filtering, and signal conditioning, to improve the signal quality. In some embodiments, the signal processing unit 108 may utilize one or more SAR algorithms 120 to process the signal data. In some embodiments, the signal processing unit 108 may utilize adaptive filtering techniques, such as the Least Mean Squares algorithm, to identify and filter out interference from the received signals. In some embodiments, the algorithms may dynamically adjust their parameters to minimize the impact of noise and interference, improving the clarity of the radar images. In some embodiments, the signal processing unit 108 may perform the Fourier Transform to identify and filter out interference, improving signal purity. The Fourier Transform and its fast implementation, known as the Fast Fourier Transform, or FFT, may be used to convert time-domain signals into their frequency components. By transforming the signal into the frequency domain, it becomes easier to identify and filter out unwanted frequency components or interference. In some embodiments, the signal processing unit 108 may perform Wavelet Transform to identify and filter out interference to improve signal purity. The Wavelet Transform may provide a way to analyze signals at different scales or resolutions. In some embodiments, the Wavelet Transform may identify transient interferences that vary over time. In some embodiments, the signal processing unit 108 may perform Matched filtering, which may be used to maximize the signal-to-noise ratio by correlating the received signal with a known reference signal or template. In some embodiments, the signal processing unit 108 may perform Notch filtering, which may be used to attenuate specific narrowband frequencies to remove interference at those frequencies while leaving the rest of the signal spectrum relatively untouched. In some embodiments, the signal processing unit 108 may perform Kalman filtering, which may provide optimal estimates of the signal state by combining noisy measurements over time. In some embodiments, the signal processing unit 108 may perform Blind Source Separation, or BSS, which may be used to separate mixed signals into their original components without prior knowledge of the source signals using techniques such as Independent Component Analysis or ICA. In some embodiments, the signal processing unit 108 and SAR algorithms 120 may produce high-resolution images. In some embodiments, the processed data, including images and other extracted information, may be stored and managed within the system. In some embodiments, the data may be transmitted to other components, such as a user device 146 or cloud 124 storage (including a centralized server and/or distributed server, including a peer-to-peer server), for further analysis, display, or interaction.

Further, embodiments may include a system controller 110, which may manage precise timing and synchronization of radar signal transmission and reception, coordinate the electronic beam steering of the phased array antenna 104, and adjust system configurations based on task requirements. The system controller 110 may manage data acquisition to ensure the integrity and flow of raw data from the receiver is integrated with the signal processing unit 108 to facilitate real-time data processing using SAR algorithms 120. This real-time data processing, a hallmark of our system, ensures efficient and timely results. In some embodiments, the system controller 110 may continuously monitor the status and health of the radar system, performing diagnostics and initiating corrective actions when necessary to maintain reliability. In some embodiments, the system controller 110 may provide a user interface for operators to control and monitor the system, adjust settings, and visualize data. In some embodiments, the system controller 110 may manage communication with external components such as cloud 124 infrastructure and user devices 146 to ensure secure data transmission. In some embodiments, the system controller 110 may integrate data from other sensors to enhance situational awareness and provide comprehensive data analysis.

Further, embodiments may include a processor 112, which may be responsible for executing instructions and processing data. The processor 112 may interpret and perform commands from software applications and perform calculations necessary for tasks. In some embodiments, the processor 112 may include microcontrollers in embedded systems, multi-core central processing units, or CPUs in high-performance computing environments. In some embodiments, the processor 112 may manage tasks such as arithmetic operations, logical decisions, and data manipulation, coordinating the activities of all other components within the system. In some embodiments, the processor 112 may manage the real-time processing of raw radar data received from the antenna 104 and execute SAR algorithms 120 such as the Range-Doppler Algorithm, Chirp Scaling Algorithm, and others to generate high-resolution images. In some embodiments, the processor 112 may manage system operations, such as coordinating the timing of signal transmission and reception, controlling the electronic beam steering of the phased array antenna 104, and optimizing system configurations for specific missions. In some embodiments, the processor 112 may oversee the integration of data from other sensors and external systems, facilitate user interaction through the system interface, and ensure the efficient handling of data storage and communication.

Further, embodiments may include a communication interface 114, which may facilitate the exchange of data between different devices or systems. The communication interface 114 may serve as a bridge that enables communication by providing a standard set of rules and protocols for transmitting and receiving data. In some embodiments, the communication interface 114 may be wired, such as Ethernet, USB, or serial ports, or wireless, such as Wi-Fi, Bluetooth, or cellular networks, and enable connectivity between hardware components, external devices, and networks. In some embodiments, the communication interface 114 may manage the data flow between the SAR antenna 102 system and external components, such as user devices 146, cloud 124 storage, and other sensors. In some embodiments, the communication interface 114 may manage the transmission of raw and processed radar data to ensure that images and other information are sent securely and efficiently to their intended destinations. In some embodiments, the communication interface 114 may enable real-time data sharing and remote monitoring, allowing operators to control the system and access data from different locations.

Further, embodiments may include a power source 116, which may supply electrical energy to the SAR antenna 102, enabling it to operate. In some embodiments, the power source 116 may include batteries, generators, power supplies, and the electrical grid. In some embodiments, the power source 116 may provide the necessary voltage and current to run electronic circuits and components, converting energy from various forms, such as chemical or mechanical, into electrical energy. In some embodiments, the power source 116 may provide the electrical energy to operate various components of the SAR antenna 102, including the phased array antenna 104, radar transmitter and receiver 106, signal processing unit 108, and system controller 110. In some embodiments, the power source 116 may include power management systems to monitor and regulate power usage, ensuring efficient energy consumption and preventing system overloads or failures.

Further, embodiments may include a memory 118, which may be used to store data and instructions temporarily or permanently. The memory 118 provides a space where information can be saved, accessed, and manipulated by the processor 112. In some embodiments, the memory 118 may be volatile memory, such as RAM, which loses data when powered off, and non-volatile memory, such as SSDs and HDDs, which retain data even when not powered. In some embodiments, the memory 118 subsystem may be used to temporarily hold raw data collected by the radar receiver 106, enabling the system to process and analyze the information using SAR algorithms 120, which may include both volatile memory, which is used for quick data access and processing during real-time operations, and non-volatile memory, which store large datasets, including radar images, processed data, and system logs. In some embodiments, the memory 118 system may manage the SAR algorithms 120 and the processing module 122, where complex computations and image processing tasks are performed. In some embodiments, the memory 118 may support the storage of historical data, which may be used for comparative analysis and enhancing the accuracy of radar imaging.

Further, embodiments may include SAR algorithms 120, which may be a set of specialized computational techniques used to process the raw data collected by SAR systems into high-resolution images. The SAR system may use radar to create detailed images of landscapes, buildings, and other objects, even in adverse weather conditions or at night. The SAR algorithms may convert complex radar data into meaningful images and analyses, allowing for accurate interpretation and application in various fields such as environmental monitoring, military surveillance, urban planning, and disaster management. In some embodiments, the SAR algorithms 120 may include the Range-Doppler Algorithm, which may compress the signal in the range, distance, and dimension using matched filtering that enhances the signal-to-noise ratio. Then Doppler processing is performed, which compresses the signal in the azimuth, along-track, dimension. The data is then transformed into the frequency domain using the Fast Fourier Transform. In some embodiments, the RDA may generate detailed 2D images from SAR data. In some embodiments, the SAR algorithms 120 may include the Chirp Scaling Algorithm, which may be designed to handle wide swath and high-resolution data more efficiently. The Chirp Scaling Algorithm may correct for range cell migration effects, a phenomenon where the signal's path varies due to changes in the distance between the radar and the target. The algorithm may apply a range frequency scaling operation, followed by range and azimuth compression, to produce highly accurate images. In some embodiments, the SAR algorithm 120 may include the Polar Format Algorithm or PFA, in which the radar focuses on a small area to achieve higher resolution. The PFA converts polar-format data into Cartesian coordinates, making it easier to process and analyze. The algorithm may involve resampling data from polar coordinates to Cartesian coordinates, followed by a Fourier Transform to create the final image. In some embodiments, the SAR algorithm 120 may include the Backprojection Algorithm, or BPA, which processes SAR data directly in the time domain, unlike frequency-domain methods such as RDA and CSA. The BPA may sum the contributions of radar returns over time, calculating the image by integrating radar echoes at each pixel location. In some embodiments, the SAR algorithm 120 may include spotlight and stripmap processing. Spotlight processing may focus on a small area for an extended period, achieving higher resolution, while stripmap mode continuously scans along a wide swath. In some embodiments, the SAR algorithms 120 may include Interferometric SAR, Coherent Change Detection, Polarimetric SAR, etc.

Further, embodiments may include a processing module 122, which may be responsible for transforming raw radar data into detailed images and information. The processing module 122 may begin with activating the SAR Antenna 102 and collecting the radar signals reflected from the target area. The raw data is then processed to remove noise and prepare it for analysis. SAR algorithms 120, such as the Range-Doppler and Chirp Scaling Algorithms, may be applied to reconstruct high-resolution images. The processing module 122 performs additional signal processing to enhance the clarity and detail of the images. The processed data is then securely transmitted to the cloud 124 for storage and further analysis, and the process returns to collecting the SAR antenna 102 data.

Further, embodiments may include a cloud 124, which may perform data storage, processing, and management to deliver accurate and detailed imagery and analysis. The cloud 124 integrates data from various sources, including SAR antenna 102 data, ground-based visual data, aerial visual data from drones, and historical data. In some embodiments, the cloud 124 may include a communication interface 126, memory 128, base module 130, generative AI module 132, a sensor data integrator 134, a drone data integrator 136, and a historical data integrator 138. The base module 130 may manage the ingestion, organization, and preliminary processing of data from various inputs ensuring that data is correctly formatted and indexed, making it ready for further processing and analysis. The generative AI module 132 may enhance the data's quality by leveraging algorithms to fill in gaps and improve (e.g., increase) the resolution of imagery. The generative AI module 132 may integrate data from various sources, such as ground-based visual data and aerial visual data from drones, using data fusion techniques. The AI processes the combined data, correcting for any inconsistencies and enhancing the overall dataset, thus providing a comprehensive and detailed view of the environment.

Further, embodiments may include a communication interface 126, which may facilitate the transfer of data between devices or systems. The communication interface 126 may establish the protocols and methods through which information is transmitted and received, enabling seamless connectivity. In some embodiments, the communication interface 126 may be physical, such as Ethernet ports, USB connections, or wireless, such as Wi-Fi and Bluetooth, and support various protocols like TCP/IP, HTTP, or specialized communication protocols. In some embodiments, the communication interface 126 may facilitate the transfer of data between the cloud 124 infrastructure and other system components, including the SAR antenna 102, user devices 146, and external data sources, ensuring that raw and processed radar data, as well as additional sensor inputs, are securely and efficiently transmitted to the cloud 124 for storage, further processing, and analysis. In some embodiments, the communication interface 126 may support a plurality of connection methods, including high-speed internet connections, VPNs, and secure data transfer protocols to ensure data integrity and security. In some embodiments, the communication interface 126 may enable real-time data streaming and synchronization, allowing the cloud 124 to process data as it is received. In some embodiments, the communication interface 126 may support bi-directional communication, such as receiving data from the SAR system 102 and sending processed information back to user devices 146 or other components for visualization, decision-making, or further action. In some embodiments, the system 100 may send visualization data directly to a user device for display and interaction. However, in some embodiments the system 100 may send the data to other possible locations, examples of which include, but are not limited to, centralized servers, distributed servers, and/or decentralized servers, after which the data is sent to a user's device, which can take many forms, such as a mobile phone, laptop, desktop, VR/AR headset, portable system, etc. In some embodiments, the distributed and/or decentralized servers may include blockchain topologies, directed acrylic graphs, and/or other distributed computing/processing topologies that are capable of acting as a server.

In some embodiments, artificial intelligence (AI) and/or machine learning (ML) may be used to detect people, animals, objects and any possible events occurring on the visualized data. Examples of events may include, but are not limited to, a vehicle is approaching, a vehicle has parked next to the building, a vehicle parked next to the building and two individuals got out of the vehicle and are walking towards the buildings entrance, etc.

Further, embodiments may include a memory 128, which may store data and instructions, either temporarily or permanently. In some embodiments, the memory 128 may include volatile memory and non-volatile memory. In some embodiments, the volatile memory, such as RAM, may be used for real-time data processing and temporary storage of active datasets, enabling the cloud 124 to handle large volumes of incoming data from the SAR antenna 102, process it, and manage it efficiently during real-time operations. In some embodiments, non-volatile memory, such as SSDs and HDDs, may provide long-term storage solutions and may be used to store large datasets, such as raw radar data, processed images, historical data, and other valuable information that needs to be retained for future analysis or regulatory compliance.

Further, embodiments may include a base module 130, which may provide data integration and management. The base module 130 connects to the SAR Antenna 102 to receive processed radar data and establishes secure connections with third-party sources, including ground-based visual data 140, aerial data 142, and architectural data 144. The base module 130 collects and standardizes the diverse data, then sends it to the generative AI module 132 for further analysis and enhancement, and the process returns to receiving the data from the processing module 122.

Further, embodiments may include a generative AI module 132, which processes and enhances data from various sources, including SAR, ground-based visual data, aerial data from drones, and historical data. The generative AI module 132 begins by being initiated by the base module 130 and receiving integrated data. The generative AI module 132 executes specific integrators for sensor data, drone data, and historical data to combine and enhance the information. The processed output is stored in memory 128 and then sent to the user device 146, providing detailed images and insights for analysis, decision-making, and integration into various applications. The module then returns to the base module 130.

Further, embodiments may include a sensor data integrator 134, which may be responsible for aggregating, aligning, and synthesizing data from various sources, including the SAR antenna 102 system and 3rd party ground-based visual data 140. The sensor data integrator 134 may enhance the overall quality and accuracy of the output imagery and data by combining the data of each data source. In some embodiments, the sensor data integrator 134 may receive the data from the SAR antenna 102, which includes radar-generated imagery and measurements, and from 3rd party ground-based visual data 140 sources such as street cameras and traffic light cameras, from the base module 130. In some embodiments, the data aggregation may involve importing data streams in various formats and from different types of sensors, ensuring that the system captures a comprehensive view of the environment. In some embodiments, the sensor data integrator 134 may synchronize the data temporally and spatially, which may involve aligning data from different sensors based on timestamps and geospatial coordinates. In some embodiments, the sensor data integrator 134 may utilize data fusion techniques to merge the SAR data with ground-based visual data, which may involve combining the radar's extensive coverage and penetrating capabilities with the high-resolution, detailed views provided by visual sensors. In some embodiments, the sensor data integrator 134 may perform error correction and data calibration to address discrepancies between different data sources, which may include adjusting for differences in sensor resolutions, correcting geometric distortions, and aligning data points that may be affected by sensor noise or environmental factors. In some embodiments, the sensor data integrator may utilize algorithms to enhance the quality of the combined data, including sharpening blurred areas, enhancing contrast, and filling in gaps where data may be incomplete or inconsistent, resulting in a coherent and highly detailed composite image or dataset. For example, the process may begin with the ingestion of raw data from the SAR antenna 102 system and ground-based visual sensors. The SAR antenna 102 system provides radar images and range data, while the visual sensors contribute high-resolution images and video footage. The sensor data integrator 134 may use timestamps and GPS coordinates to align the data from both sources, which involves matching the time of data capture and aligning the spatial coordinates to ensure that both datasets refer to the same physical locations. In some embodiments, time interpolation and geospatial mapping techniques may be used to achieve precise alignment. The data may be normalized to account for differences in scale, resolution, and perspective to ensure that the different datasets may be seamlessly merged. For example, radar data may need to be rescaled to match the resolution of visual data, or visual data may need to be reprojected to match the SAR data's coordinate system. The sensor data integrator 134 may then apply data fusion techniques, which may involve combining the depth and material penetration capabilities of SAR data with the surface-level detail and color information from visual data. In some embodiments, various algorithms, including image registration and blending techniques, may be used to create a single, cohesive image that integrates information from both sources. The sensor data integrator 134 may perform error correction to address any inconsistencies or artifacts that may have arisen during the integration process, including correcting any remaining geometric distortions and enhancing the image quality. In some embodiments, filtering, de-noising, and contrast enhancement techniques may be applied to produce a clear and accurate final product. The enhanced image or dataset may be generated, which may be used for various applications. In some embodiments, the output may be stored and made accessible for further analysis, visualization, or decision-making processes.

Further, embodiments may include a drone data integrator 136, which may incorporate aerial visual data collected by drones with SAR data to create a comprehensive and detailed representation of the surveyed area. The drone data integrator 136 may collect high-resolution imagery and video data from various drones equipped with cameras and sensors. In some embodiments, aerial data may provide an overhead perspective, capturing details that ground-based systems might miss, such as the tops of buildings, large infrastructure, and extensive landscapes. In some embodiments, the drone data integrator 136 may align the drone-collected data with SAR data based on timestamps and geospatial coordinates. In some embodiments, the drone data integrator 136 may perform synchronization to ensure that the data from both sources corresponds to the same physical locations and timeframes. In some embodiments, the drone data integrator 136 may normalize the data from drones and the SAR system, which may involve adjusting for differences in resolution, scale, and perspective, as well as calibrating sensor data to correct for any discrepancies in sensor outputs or environmental effects. The drone data integrator 136 may employ data fusion techniques to combine the SAR data with the aerial visual data from drones. The drone data integrator 136 may perform error correction to address any anomalies or inconsistencies in the combined data. For example, the drone data integrator 136 may begin by ingesting raw data from the SAR system and drones. The SAR antenna 102 system may provide radar images and range data, while the drones contribute high-resolution aerial images and videos. The drone data integrator 136 may align the datasets using precise timestamps and geospatial coordinates. In some embodiments, temporal alignment may ensure that the images and data from different sources correspond to the same time period. In some embodiments, spatial alignment may involve mapping the data onto a common coordinate system to ensure that features and objects are accurately located across datasets. The drone data integrator 136 may normalize the data to handle differences in resolution, scale, and perspective between the drone imagery and SAR data to create a seamless fusion of the two datasets, ensuring that all data points are consistent and comparable. The drone data integrator 136 may combine the SAR and aerial visual data using sophisticated data fusion algorithms. In some embodiments, the algorithms may blend the different types of data, leveraging the strengths of each, such as the SAR data providing extensive coverage and penetrating certain materials. In contrast, the drone data offers high-resolution, detailed surface images. In some embodiments, image registration, multi-resolution analysis, and spectral blending techniques may be employed to ensure that the fused data maintains high quality and accuracy. The drone data integrator 136 may perform error correction to resolve any issues such as geometric distortions, alignment errors, or inconsistencies in the data, including enhancing image quality by adjusting brightness, contrast, and sharpness, as well as applying filters to remove noise or artifacts. The generated output may be a highly detailed and accurate composite image or dataset that integrates the strengths of both SAR and aerial visual data. In some embodiments, the output may be stored and made available for further analysis,

[symbol]

FIG. 2 illustrates the processing module 122. The process begins with the processing module 122 activating, at step 200, the SAR antenna 102. In some embodiments, activating the SAR antenna 102 may involve powering up the antenna and preparing it for data collection. In some embodiments, the activation process may include setting the appropriate operational parameters, such as frequency, pulse duration, and beam steering configurations. The processing module 122 collects, at step 202, the antenna data. In some embodiments, the SAR antenna 102 may capture the radar signals reflected from the target area. The antenna transmits radio waves that bounce off objects and surfaces, returning echoes to the receiver. The echoes are recorded as raw antenna data, which includes both the amplitude and phase information of the returned signals. In some embodiments, the data collected provides a comprehensive set of measurements that represent the characteristics of the observed area, including distances, surface textures, and material properties. The processing module 122 processes, at step 204, the raw antenna data. In some embodiments, the raw data may be processed by performing initial filtering to remove noise and unwanted signals, and digitization if the data is in analog form. In some embodiments, the processing may also include calibration adjustments to correct any deviations caused by environmental factors or hardware limitations. In some embodiments, the data may be organized and formatted for compatibility with subsequent processing steps, ensuring that it can be efficiently handled and analyzed by the system. The processing module 122 performs, at step 206, the SAR algorithms 120. In some embodiments, the algorithms may transform the raw radar signals into detailed images. The SAR algorithms 120 may include techniques such as the Range-Doppler Algorithm, Chirp Scaling Algorithm, Polar Format Algorithm, and Backprojection Algorithm. In some embodiments, each algorithm may have specific functions, such as compressing signal data, correcting for range migration, and converting data formats. In some embodiments, the algorithms may reconstruct the scene by focusing the radar data, which results in high-resolution images that accurately represent the scanned area. For example, the SAR algorithms 120 may be a set of specialized computational techniques used to process the raw data collected by SAR systems into high-resolution images. The SAR system may use radar to create detailed images of landscapes, buildings, and other objects, even in adverse weather conditions or at night. The SAR algorithms may convert complex radar data into meaningful images and analyses, allowing for accurate interpretation and application in various fields such as environmental monitoring, military surveillance, urban planning, and disaster management. In some embodiments, the SAR algorithms 120 may include the Range-Doppler Algorithm, which may compress the signal in the range, distance, and dimension using matched filtering that enhances the signal-to-noise ratio. Then Doppler processing is performed, which compresses the signal in the azimuth, along-track, dimension. The data is then transformed into the frequency domain using the Fast Fourier Transform. In some embodiments, the RDA may generate detailed 2D images from SAR data. In some embodiments, the SAR algorithms 120 may include the Chirp Scaling Algorithm, which may be designed to handle wide swath and high-resolution data more efficiently. The Chirp Scaling Algorithm may correct for range cell migration effects, a phenomenon where the signal's path varies due to changes in the distance between the radar and the target. The algorithm may apply a range frequency scaling operation, followed by range and azimuth compression, to produce highly accurate images. In some embodiments, the SAR algorithm 120 may include the Polar Format Algorithm or PFA, in which the radar focuses on a small area to achieve higher resolution. The PFA converts polar-format data into Cartesian coordinates, making it easier to process and analyze. The algorithm may involve resampling data from polar coordinates to Cartesian coordinates, followed by a Fourier Transform to create the final image. In some embodiments, the SAR algorithm 120 may include the Backprojection Algorithm, or BPA, which processes SAR data directly in the time domain, unlike frequency-domain methods such as RDA and CSA. The BPA may sum the contributions of radar returns over time, calculating the image by integrating radar echoes at each pixel location. In some embodiments, the SAR algorithm 120 may include spotlight and stripmap processing. Spotlight processing may focus on a small area for an extended period, achieving higher resolution, while stripmap mode continuously scans along a wide swath. In some embodiments, the SAR algorithms 120 may include Interferometric SAR, Coherent Change Detection, Polarimetric SAR, etc.

The processing module 122 executes, at step 208, signal processing. In some embodiments, the processing tasks may involve refining the images and data to enhance clarity and detail. In some embodiments, noise reduction, contrast enhancement, and edge sharpening techniques may be applied to improve the overall quality of the output. In some embodiments, the signal processing may include filtering techniques to remove residual artifacts and distortions, ensuring that the final images are as accurate and detailed as possible. The signal processing unit 108 may handle the complex tasks of analyzing the radar signals received from the antenna 104 and applying various algorithms to extract, enhance, and interpret the data. The signal processing unit 108 may receive digitized signals from the radar receiver after they have been amplified and downconverted. In some embodiments, the signals may represent the raw data collected by the radar system, including information about the range, velocity, and possibly the shape of objects in the radar's field of view. In some embodiments, the raw data may undergo preprocessing before applying various algorithms, including noise reduction, filtering, and signal conditioning, to improve the signal quality. In some embodiments, the signal processing unit 108 may utilize a plurality of SAR algorithms 120 to process the signal data. In some embodiments, the signal processing unit 108 may utilize adaptive filtering techniques, such as the Least Mean Squares algorithm, to identify and filter out interference from the received signals. In some embodiments, the algorithms may dynamically adjust their parameters to minimize the impact of noise and interference, improving the clarity of the radar images. In some embodiments, the signal processing unit 108 may perform the Fourier Transform to identify and filter out interference, improving signal purity. The Fourier Transform and its fast implementation, known as the Fast Fourier Transform, or FFT, may be used to convert time-domain signals into their frequency components. By transforming the signal into the frequency domain, it becomes easier to identify and filter out unwanted frequency components or interference. In some embodiments, the signal processing unit 108 may perform Wavelet Transform to identify and filter out interference to improve signal purity. The Wavelet Transform may provide a way to analyze signals at different scales or resolutions. In some embodiments, the Wavelet Transform may identify transient interferences that vary over time. In some embodiments, the signal processing unit 108 may perform Matched filtering, which may be used to maximize the signal-to-noise ratio by correlating the received signal with a known reference signal or template. In some embodiments, the signal processing unit 108 may perform Notch filtering, which may be used to attenuate specific narrowband frequencies to remove interference at those frequencies while leaving the rest of the signal spectrum relatively untouched. In some embodiments, the signal processing unit 108 may perform Kalman filtering, which may provide optimal estimates of the signal state by combining noisy measurements over time. In some embodiments, the signal processing unit 108 may perform Blind Source Separation, or BSS, which may be used to separate mixed signals into their original components without prior knowledge of the source signals using techniques such as Independent Component Analysis or ICA. In some embodiments, the signal processing unit 108 and SAR algorithms 120 may produce high-resolution images. In some embodiments, the processed data, including images and other extracted information, may be stored and managed within the system. In some embodiments, the data may be transmitted to other components, such as a user device 146 or cloud 124 storage, for further analysis or display. The processing module 122 connects, at step 210, to the cloud 124. In some embodiments, the connection may include establishing a secure data transmission channel to transfer the processed data to the cloud 124 for storage, further analysis, and integration with other datasets. In some embodiments, the connection may utilize various communication protocols, such as secure internet connections, VPNs, or dedicated network lines, depending on the system's architecture and security requirements. The processing module 122 sends, at step 212, the processed data to the cloud 124 and the process returns to activating the SAR antenna 102. The data may include the high-resolution images generated from the SAR algorithms 120 and any additional processed outputs, such as analytical results or metadata. In some embodiments, the cloud 124 may serve as the central repository for all collected and processed data, enabling further data fusion with ground-based, aerial, and historical data, additional processing with generative AI, and access for end-users via user devices.

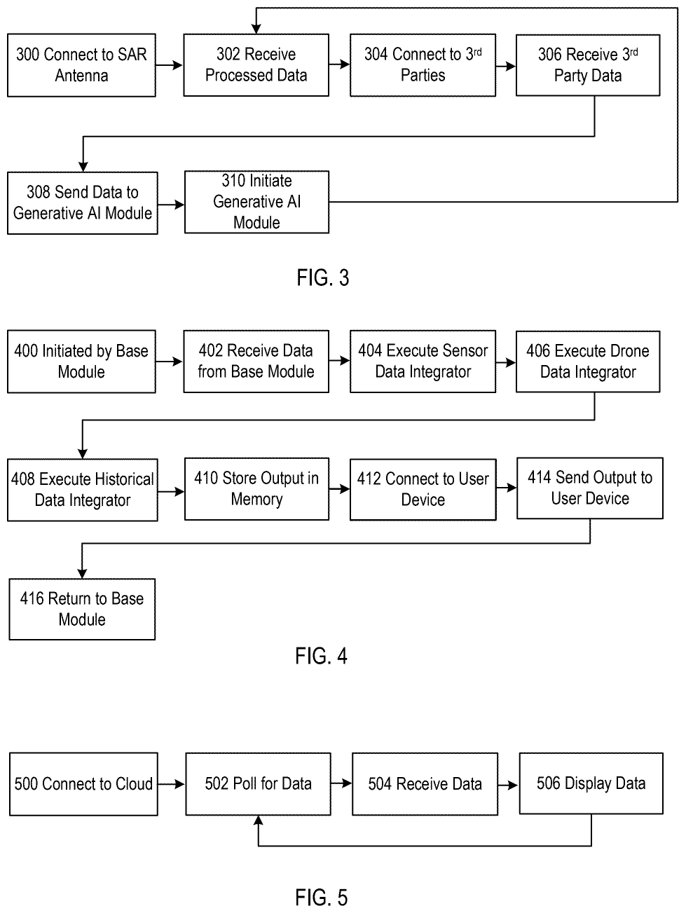

FIG. 3 illustrates the base module 130. The process begins with the base module 130 connecting, at step 300, to the SAR antenna 102. The base module 130 establishes a connection with the SAR Antenna 102. In some embodiments, the connection may facilitate the direct flow of data between the SAR antenna 102 and the base module 130. In some embodiments, the connection setup may include establishing secure communication channels and configuring the data transfer protocols. The base module 130 receives, at step 302, the processed data from the processing module 122. The data may include high-resolution images and other relevant information extracted from the raw radar signals. In some embodiments, the processed data may have undergone initial filtering, signal processing, and application of SAR algorithms 120. In some embodiments, the base module 130 may store the data temporarily and prepare it for subsequent steps. The base module 130 connects, at step 304, to the 3rd parties, such as the 3rd party ground-based visual data 140, 3rd party aerial data 152, and 3rd party architectural data 152. In some embodiments, the connection process may involve setting up secure communication links with external systems and databases, ensuring the integrity and confidentiality of the data transferred. The base module 130 receives, at step 306, the 3rd party data. The data may include various types of information, such as real-time video feeds from street cameras from the 3rd party ground-based visual data 140, aerial imagery from drones from the 3rd party aerial data 152, and historical records or blueprints from the 3rd party architectural data 154. In some embodiments, the base module 130 may ensure that the data is collected efficiently and securely. In some embodiments, the base module 130 may standardize and organize the data, aligning it with the SAR data's formats and structures to facilitate integration and analysis. The base module 130 sends, at step 308, the data to the generative AI module 132. In some embodiments, the generative AI module 132 may be responsible for applying AI techniques to the data, such as filling in gaps, enhancing image quality, and integrating multiple data sources into cohesive visualizations. In some embodiments, the data transfer may involve securely sending large volumes of information, ensuring that all relevant data points are included for comprehensive processing by the generative AI. The base module 130 initiates, at step 310, the generative AI module 132, and the process returns to receiving the data from the SAR antenna 102. In some embodiments, the base module 130 activates the AI processes and algorithms that will analyze and enhance the data. The initiation process may include setting parameters for the AI's operations, such as defining the scope of data integration, setting thresholds for quality enhancement, and specifying the outputs required.

FIG. 4 illustrates the generative AI module 132. The process begins with the generative AI module 132 being initiated at step 400 by the base module 130. The generative AI module 132 receives, at step 402, the data from the base module 130. The data may include processed SAR data, as well as third-party data such as ground-based visual, aerial, and architectural information. In some embodiments, the data received is a comprehensive set of inputs that provide a detailed view of the target area. The generative AI module 132 executes, at step 404, the sensor data integrator 134. The sensor data integrator 134 may be responsible for aggregating, aligning, and synthesizing data from various sources, including the SAR antenna 102 system and 3rd party ground-based visual data 140. The sensor data integrator 134 may enhance the overall quality and accuracy of the output imagery and data by combining the data of each data source. In some embodiments, the sensor data integrator 134 may receive the data from the SAR antenna 102, which includes radar-generated imagery and measurements, and from 3rd party ground-based visual data 140 sources such as street cameras and traffic light cameras, from the base module 130. In some embodiments, the data aggregation may involve importing data streams in various formats and from different types of sensors, ensuring that the system captures a comprehensive view of the environment. In some embodiments, the sensor data integrator 134 may synchronize the data temporally and spatially, which may involve aligning data from different sensors based on timestamps and geospatial coordinates. In some embodiments, the sensor data integrator 134 may utilize data fusion techniques to merge the SAR data with ground-based visual data, which may involve combining the radar's extensive coverage and penetrating capabilities with the high-resolution, detailed views provided by visual sensors. In some embodiments, the sensor data integrator 134 may perform error correction and data calibration to address discrepancies between different data sources, which may include adjusting for differences in sensor resolutions, correcting geometric distortions, and aligning data points that may be affected by sensor noise or environmental factors. In some embodiments, the sensor data integrator may utilize one or more algorithms to enhance the quality of the combined data, including sharpening blurred areas, enhancing contrast, and filling in gaps where data may be incomplete or inconsistent, resulting in a coherent and highly detailed composite image or dataset. For example, the process may begin with the ingestion of raw data from the SAR antenna 102 system and ground-based visual sensors. The SAR antenna 102 system provides radar images and range data, while the visual sensors contribute high-resolution images and video footage. The sensor data integrator 134 may use timestamps and GPS coordinates to align the data from both sources, which involves matching the time of data capture and aligning the spatial coordinates to ensure that both datasets refer to the same physical locations. In some embodiments, time interpolation and geospatial mapping techniques may be used to achieve precise alignment. The data may be normalized to account for differences in scale, resolution, and perspective to ensure that the different datasets may be seamlessly merged. For example, radar data may need to be rescaled to match the resolution of visual data, or visual data may need to be reprojected to match the SAR data's coordinate system. The sensor data integrator 134 may then apply data fusion techniques, which may involve combining the depth and material penetration capabilities of SAR data with the surface-level detail and color information from visual data. In some embodiments, various algorithms, including image registration and blending techniques, may be used to create a single, cohesive image that integrates information from both sources. The sensor data integrator 134 may perform error correction to address any inconsistencies or artifacts that may have arisen during the integration process, including correcting any remaining geometric distortions and enhancing the image quality. In some embodiments, filtering, de-noising, and contrast enhancement techniques may be applied to produce a clear and accurate final product. The enhanced image or dataset may be generated, which may be used for various applications. In some embodiments, the output may be stored and made accessible for further analysis, visualization, or decision-making processes.

The generative AI module 132 executes, at step 406, the drone data integrator 136. The drone data integrator 136 may incorporate aerial visual data collected by drones with SAR data to create a comprehensive and detailed representation of the surveyed area. The drone data integrator 136 may collect high-resolution imagery and video data from various drones equipped with cameras and sensors. In some embodiments, aerial data may provide an overhead perspective, capturing details that ground-based systems might miss, such as the tops of buildings, large infrastructure, and extensive landscapes. In some embodiments, the drone data integrator 136 may align the drone-collected data with SAR data based on timestamps and geospatial coordinates. In some embodiments, the drone data integrator 136 may perform synchronization to ensure that the data from both sources corresponds to the same physical locations and timeframes. In some embodiments, the drone data integrator 136 may normalize the data from drones and the SAR system, which may involve adjusting for differences in resolution, scale, and perspective, as well as calibrating sensor data to correct for any discrepancies in sensor outputs or environmental effects. The drone data integrator 136 may employ data fusion techniques to combine the SAR data with the aerial visual data from drones. The drone data integrator 136 may perform error correction to address any anomalies or inconsistencies in the combined data. For example, the drone data integrator 136 may begin by ingesting raw data from the SAR system and drones. The SAR antenna 102 system may provide radar images and range data, while the drones contribute high-resolution aerial images and videos. The drone data integrator 136 may align the datasets using precise timestamps and geospatial coordinates. In some embodiments, temporal alignment may ensure that the images and data from different sources correspond to the same time period. In some embodiments, spatial alignment may involve mapping the data onto a common coordinate system to ensure that features and objects are accurately located across datasets. The drone data integrator 136 may normalize the data to handle differences in resolution, scale, and perspective between the drone imagery and SAR data to create a seamless fusion of the two datasets, ensuring that all data points are consistent and comparable. The drone data integrator 136 may combine the SAR and aerial visual data using sophisticated data fusion algorithms. In some embodiments, the algorithms may blend the different types of data, leveraging the strengths of each, such as the SAR data providing extensive coverage and penetrating certain materials. In contrast, the drone data offers high-resolution, detailed surface images. In some embodiments, image registration, multi-resolution analysis, and spectral blending techniques may be employed to ensure that the fused data maintains high quality and accuracy. The drone data integrator 136 may perform error correction to resolve any issues such as geometric distortions, alignment errors, or inconsistencies in the data, including enhancing image quality by adjusting brightness, contrast, and sharpness, as well as applying filters to remove noise or artifacts. The generated output may be a highly detailed and accurate composite image or dataset that integrates the strengths of both SAR and aerial visual data. In some embodiments, the output may be stored and made available for further analysis, visualization, or decision-making processes, ensuring that users have access to the most comprehensive and reliable data.

The generative AI module 132 executes, at step 408, the historical data integrator 138. The historical data integrator 138 may incorporate historical data, such as architectural plans, historical photographs, and records, with the real-time data collected by the SAR antenna 102 system and aerial visual data from drones. The historical data integrator may collect historical data from various sources, including archives, databases, and institutional records. In some embodiments, the data may include blueprints, construction plans, historical photographs, zoning maps, and other documents that provide detailed historical and structural information. In some embodiments, the historical data integrator 138 may digitize historical documents and images by converting them into digital formats suitable for analysis and integration with modern datasets. In some embodiments, the process may include scanning, OCR, or Optical Character Recognition for text data and image digitization. The historical data integrator 138 may align the historical data with the current SAR based on temporal and spatial references. In some embodiments, the historical data integrator 138 may normalize the historical data that may be collected from various sources with different levels of detail and accuracy, ensuring consistency in scale, resolution, and perspective. In some embodiments, calibration may be performed to correct any inaccuracies or distortions in the historical data, making it compatible with contemporary datasets. The historical data integrator 138 may fuse the historical data with the real-time SAR data, providing a multi-temporal and multi-perspective view, integrating historical and current information to offer a richer, more detailed understanding of the environment. For example, the historical data integrator 138 may begin by ingesting data from the SAR system and historical data sources, which may involve both real-time acquisition from active sensors and retrieval from historical archives and databases. The historical documents may be digitized and processed to make them suitable for integration, including converting physical blueprints and photographs into digital formats, extracting relevant text and image data, and organizing it for further analysis. The historical data integrator 138 may use historical records and geographic information to align the historical data with the SAR data, which may involve matching historical landmarks and geographic features with current ones, ensuring that all data aligns accurately over time and space. In some embodiments, historical georeferencing and temporal interpolation techniques may be used to achieve precise alignment. The historical data may be normalized to match the scale and resolution of the contemporary data, which may include adjusting the size and perspective of historical images and ensuring that textual and numerical data from different periods are compatible. The historical data integrator 138 may combine the SAR and historical data into a single, unified dataset. In some embodiments, the fusion may involve integrating the broad, penetrating capabilities of SAR data with the contextual richness of historical data. In some embodiments, algorithms may be employed to merge these datasets to ensure that the final output maintains coherence and accuracy. The historical data integrator 138 may perform error correction to address any inconsistencies or anomalies that may have arisen during the integration process. In some embodiments, quality enhancement techniques may be applied to improve the clarity and detail of the fused data, such as enhancing historical images or refining the alignment of historical and current data points. The output generated may be a comprehensive dataset that integrates historical and current perspectives. In some embodiments, the historical data integrator 138 may use an iterative closest point, or ICP, algorithm, which focuses on iteratively matching the closest points between datasets and minimizing the distance between them through transformation adjustments. For example, the historical data integrator 138 may convert the historical and current 3D datasets into a compatible format, such as point clouds. The historical data integrator 138 may reduce the number of points in both datasets to make the processing more efficient while preserving essential features. The historical data integrator 138 may apply an initial transformation to roughly align the historical data with the current data. In some embodiments, this may be based on known landmarks or approximate coordinates. The historical data integrator 138 may for each point in the historical dataset, find the closest point in the current dataset to establish point correspondences between the two datasets. The historical data integrator 138 may calculate the transformation, such as the rotation and translation, that minimizes the distance between the matched points, which may be performed by using Singular Value Decomposition or other optimization methods. The historical data integrator 138 may apply the estimated transformation to the historical dataset to better align it with the current dataset. In some embodiments, the historical data integrator may compute the mean square error, or MSE, between the matched points. In some embodiments, the historical data integrator 138 may check if the MSE is below a predefined threshold or if the change in MSE between iterations is minimal. The historical data integrator 138 may apply the final transformation to the entire historical dataset. The historical data integrator 138 may integrate the aligned historical data with the current data to create a unified 3D model, which may involve merging point clouds, creating meshes, or other data fusion techniques. In some embodiments, the historical data integrator 138 may perform a coherent point drift algorithm. For example, the historical data integrator 138 may convert the historical and current 3D datasets into a compatible format, such as point clouds, and normalize the datasets to ensure they are on the same scale and have similar units of measurement. The historical data integrator 138 may set initial parameters for the algorithm, including the regularization weight and convergence criteria. The historical data integrator 138 may estimate the correspondences between points in the historical and current datasets by using a probabilistic approach to estimate these correspondences. The historical data integrator 138 may calculate the transformation that maximizes the likelihood of the correspondences estimated, which may involve adjusting the transformation parameters to align the datasets more closely. The historical data integrator 138 may apply the estimated transformation to the historical dataset and evaluate the change in the alignment quality. The historical data integrator 138 may apply the final transformation to the entire historical dataset and integrate the aligned historical data with the current data to create a unified 3D model, which may involve merging the point clouds or converting them into a common representation.

The generative AI module 132 stores, at step 410, the output in memory 128. The generative AI module 132 may store the enhanced and integrated data, which includes high-resolution images, 3D models, and analytical results. The generative AI module 132 connects, at step 412, to the user device 146. In some embodiments, the connection enables the transfer of processed data from the generative AI module 132 to the user device 146. In some embodiments, the connection setup may involve configuring communication protocols and ensuring secure data transfer channels, providing a seamless link between the cloud-based processing and the user interface. The generative AI module 132 sends, at step 414, the output to the user device 146. The output may include the enhanced images, detailed maps, and any other generated data products. In some embodiments, the output may be formatted and optimized for integration, interpretation, and interaction on the user device 146. The generative AI module 132 returns, at step 416, to the base module 130.

FIG. 5 illustrates the SAR module 148. The process begins with the SAR module 148 connecting, at step 500, to the cloud 124. The connection may involve setting up a secure and reliable communication channel between the user device 146 and the cloud 124 infrastructure. In some embodiments, the connection setup may include authentication processes, ensuring that only authorized devices can access the data. The SAR module 148 continuously polls, at step 502, to receive the data from the cloud 124. The SAR module 148 regularly checks the cloud 124 for updates or new data to ensure that the SAR module 148 receives up-to-date processed data from the system. The SAR module 148 receives, at step 504, the data from the cloud 124. The data may include high-resolution images, 3D models, and other relevant information generated by the generative AI module 132 and other processing components. In some embodiments, the SAR module 148 may perform additional tasks such as data validation, formatting, and preparation for display. In some embodiments, the received data may be used for various applications, including but not limited to augmented reality, virtual reality, etc. The SAR module 148 displays, at step 506, the data on the user device 146 display 150, and the process returns to polling for the data from the cloud 124. In some embodiments, the data may be rendered in a user-friendly format, making it accessible and interpretable for the end-users. In some embodiments, the display 150 may show various types of information, including detailed radar images, layered maps, and analytical overlays. In some embodiments, the interface may include interactive features, such as zooming, panning, and selecting different data layers, allowing users to explore the data in depth.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system comprising:
a synthetic aperture radar (SAR) antenna system including:
a phased array antenna configured to transmit radar signals toward a target area;
a signal processing unit configured to:
receive reflected radar signals from the target area; and
perform one or more SAR algorithms to convert the reflected radar signals into one or more images, video, and/or measurements of the target area; and
at least one data integrator configured to:
receive one or more of ground-based visual data, aerial data, and/or historical or architectural data;
integrate the ground-based visual data, the aerial data, and/or the historical or architectural data with the one or more images, video, and/or measurements produced by the SAR antenna system to produce a cohesive visualization; and
send the visualization to a remote system or device for storage, display and/or interaction therewith.

2. The system of claim 1, further comprising a generative AI module configured to perform one or more of:
fill one or more gaps in the one or more images, video, and/or measurements and/or the ground-based visual data, the aerial data, and/or the historical or architectural data; and/or
increase a resolution of the one or more images, video, and/or measurements and/or the ground-based visual data, the aerial data, and/or the historical or architectural data.

3. The system of claim 1, wherein the at least one data integrator is further configured to temporally and/or spatially align the ground-based visual data, the aerial data, and/or the historical or architectural data with the one or more images, video, and/or measurements produced by the SAR antenna system.

4. The system of claim 3, wherein the at least one data integrator is configured to temporally align via timestamps the ground-based visual data, the aerial data, and/or the historical or architectural data with the one or more images, video, and/or measurements produced by the SAR antenna system.

5. The system of claim 4, wherein the at least one data integrator is configured to temporally align the ground-based visual data, the aerial data, and/or the historical or architectural data with the one or more images, video, and/or measurements produced by the SAR antenna system using temporal interpolation.

6. The system of claim 3, wherein the at least one data integrator is configured to spatially align the ground-based visual data, the aerial data, and/or the historical or architectural data with the one or more images, video, and/or measurements using a registration process.

7. The system of claim 3, wherein the at least one data integrator is configured to spatially align the ground-based visual data, the aerial data, and/or the historical or architectural data with the one or more images, video, and/or measurements using spatial coordinates associated therewith.

8. The system of claim 7, wherein the spatial coordinates include global positioning system (GPS) coordinates.

9. The system of claim 1, wherein the at least one data integrator is configured to integrate the ground-based visual data, the aerial data, and/or the historical or architectural data with the one or more images, video, and/or measurements produced by the SAR antenna system using a data fusion process.

10. The system of claim 1, wherein the at least one data integrator is configured to normalize the ground-based visual data, the aerial data, the historical or architectural data, and/or or more images, video, and/or measurements to account for differences in scale, resolution, and/or perspective.

11. The system of claim 10, wherein the at least one data integrator is configured to rescale or reproject the ground-based visual data, the aerial data, the historical or architectural data to match a resolution of the one or more images, video, and/or measurements, or wherein the at least one data integrator is configured to rescale or reproject the images, video, and/or measurements to match the resolution of the ground-based visual data, the aerial data, and/or the historical or architectural data.

12. The system of claim 1, wherein the at least one data integrator includes a sensor data integrator configured to receive the ground-based visual data from one or more of data sources including one or more street cameras and/or traffic light cameras.

13. The system of claim 1, wherein the at least one data integrator includes a drone data integrator configured to receive the aerial data from one or more drones.

14. The system of claim 1, wherein the at least one data integrator includes a historical data integrator configured to receive the historical or architectural data including one or more of architectural plans, blueprints, construction plans, historical photographs, and/or zoning maps.

15. The system of claim 14, wherein the historical data integrator is configured to perform Optical Character Recognition (OCR) to produce text data from the one or more images and/or video.

16. The system of claim 1, wherein the one or more SAR algorithms include one or more of a Range-Doppler Algorithm, a Chirp Scaling Algorithm, a Polar Format Algorithm, and/or a Backprojection Algorithm.

17. The system of claim 1, wherein the signal processing unit is further configured to enhance the one or more images using at least one of noise reduction, contrast enhancement, edge sharpening, artifact or distortion removal, Kalman filtering, and/or Independent Component Analysis (ICA).

18. The system of claim 1, wherein the at least one data integrator operates in a cloud environment.

19. The system of claim 1, wherein the ground-based visual data, the aerial data, and/or the historical or architectural data are obtained from one or more third party sources.

20. The system of claim 1, wherein the visualization includes one or more of radar images, 3D models, layered maps, and analytical results.

21. The system of claim 1, wherein the remote system or device includes one or more of a user device, a centralized server, and/or a distributed or decentralized server.

22. The system of claim 21, wherein the distributed or decentralized server includes a peer-to-peer server.

23. The system of claim 1, wherein the system further includes or accesses artificial intelligence (AI) and/or machine learning (ML) to detect people, objects and/or events in the visualization.

24. A method comprising:
transmitting radar signals toward a target area via a phased array antenna of a synthetic aperture radar (SAR) antenna system;
receiving reflected radar signals from the target area;
performing, via a signal processor, one or more SAR algorithms to convert the reflected radar signals into one or more images, video, and/or measurements of the target area;
receiving one or more of ground-based visual data, aerial data, and/or historical or architectural data;
integrating the ground-based visual data, the aerial data, and/or the historical or architectural data with the one or more images, video, and/or measurements produced by the SAR antenna system to produce a cohesive visualization; and
sending the visualization to a remote system or device for storage, display and/or interaction therewith.

25. The method of claim 24, further comprising using a generative AI module to:
fill one or more gaps in the one or more images, video, and/or measurements and/or the ground-based visual data, the aerial data, and/or the historical or architectural data; and/or
increase a resolution of the one or more images, video, and/or measurements and/or the ground-based visual data, the aerial data, and/or the historical or architectural data.

26. The method of claim 24, further comprising:
temporally and/or spatially aligning the ground-based visual data, the aerial data, and/or the historical or architectural data with the one or more images, video, and/or measurements produced by the SAR antenna system.

27. The method of claim 26, wherein temporally aligning includes temporally aligning, via timestamps, the ground-based visual data, the aerial data, and/or the historical or architectural data with the one or more images, video, and/or measurements produced by the SAR antenna system.

28. The method of claim 27, wherein temporally aligning includes temporally aligning the ground-based visual data, the aerial data, and/or the historical or architectural data with the one or more images, video, and/or measurements produced by the SAR antenna system using temporal interpolation.

29. The method of claim 26, wherein spatially aligning includes spatially aligning the ground-based visual data, the aerial data, and/or the historical or architectural data with the one or more images, video, and/or measurements using a registration process.

30. The method of claim 26, wherein spatially aligning includes spatially aligning the ground-based visual data, the aerial data, and/or the historical or architectural data with the one or more images, video, and/or measurements using spatial coordinates associated therewith.

31. The method of claim 30, wherein the spatial coordinates include global positioning system (GPS) coordinates.

32. The method of claim 24, wherein integrating includes integrating the ground-based visual data, the aerial data, and/or the historical or architectural data with the one or more images, video, and/or measurements produced by the SAR antenna system using a data fusion process.

33. The method of claim 24, wherein integrating includes normalizing the ground-based visual data, the aerial data, the historical or architectural data, and/or or more images, video, and/or measurements to account for differences in scale, resolution, and/or perspective.
